(19) United States
(12) Patent Application Publication
(10) Pub. No.: US 2003/0053627 A1
(43) Pub. Date: Mar. 20, 2003

(54) Random-number generation apparatus, random-number generation method, and random-number generation program

(76) Inventor: Ken Iizuka, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/235,676

(22) Filed: Sep. 6, 2002

(30) Foreign Application Priority Data
Sep. 12, 2001 (JP) P2001-276047

(51) Int. Cl. H04L 9/00

(52) U.S. Cl. 380/46

(57) ABSTRACT

A random-number generation apparatus includes two pseudo-random-number (PN) sequence generation circuits for generating PN sequences serving as random-number generation sources, a timing generation circuit for determining the timing of random-number generation processing, two gate circuits which open according to a control signal CTT sent from the timing generation circuit, a DES encryption circuit for executing DES encryption processing according to the control signal CTT sent from the timing generation circuit, and a switch for selecting data from a plurality of items of data.

### BACKGROUND OF THE INVENTION

1. Field of the Invention

The present invention relates to random-number generation apparatuses, random-number generation methods, and random-number generation programs for generating random-number data.

2. Description of the Related Art

As network technologies have advanced these days, various services using the Internet and other networks have spread, such as electronic transaction and on-line shopping. In such services, mutual authentication for confirming the legitimacy of communication parties and encryption communication for ensuring the safety of data communication to be performed after the authentication are, for example, executed. Random numbers are generated and used in many cases for the authentication and during the process of generating a key used in the encryption communication.

Thermal noise, for example, may be used in a method for generating a random number, but it is actually difficult to implement. Usually, a pseudo-random signal such as a pseudo-random-number (PN) sequence is widely used. A PN sequence can be generated by using a shift register and an exclusive OR circuit. More specifically, for example, a PN sequence can be generated by a PN-sequence generation apparatus 100 shown in FIG. 4.

The PN-sequence generation apparatus 100 includes three shift registers 101, 102, and 103, and one exclusive-OR circuit 104.

The shift register 101 continues to send one-bit data being held to the shift register 102 and to the exclusive-OR circuit 104. The shift register 101 newly holds one-bit data sent from the exclusive-OR circuit 104, in synchronization with a predetermined clock signal, and then, sends the data to the shift register 102 and to the exclusive-OR circuit 104.

The shift register 102 continues to send one-bit data being held to the shift register 103. The shift register 102 newly holds the one-bit data sent from the shift register 101, in synchronization with a predetermined clock signal, and then, sends the data to the shift register 103.

The shift register 103 continues to send one-bit data being held to the exclusive-OR circuit 104. The shift register 103 newly holds the one-bit data sent from the shift register 102, in synchronization with a predetermined clock signal, and then, sends the data to the exclusive-OR circuit 104.

The exclusive-OR circuit 104 applies an exclusive-OR calculation to the data sent from the shift register 101 and the data sent from the shift register 103, and sends the calculation result to the shift register 101.

The PN-sequence generation apparatus 100 takes out data, “1” or “0,” being held by the shift registers 101, 102, and 103, in synchronization with a predetermined clock signal to output the three-bit string.

When a PN sequence is generated by shift registers and an exclusive-OR circuit as in the above-described PN-sequence generation apparatus 100, if the same initial value is held by each of the shift registers, the same bit strings are generated at a certain interval. In the above-described PN-sequence generation apparatus 100, for example, seven bit strings formed of data held by the shift registers 101, 102, and 103 and arranged in that order, namely, “001,” “100,” “110,” “111,” “011,” “101,” and “010,” are sequentially generated at an interval corresponding to seven (=2³−1) where “3” indicates the number of shift registers, as shown in FIG. 5.

Therefore, in a system which uses such PN sequence as random numbers and a key is generated according to the random numbers, since the identical key is generated at the same period as that of the PN sequence, tolerance is low and safety is substantially impaired.

In addition, since a PN sequence is generated by a relatively simple circuit formed of a shift register and an exclusive-OR circuit, if several bit strings are generated with random-number generation timing being gradually shifted, and correlation among the bit strings is checked in a system which uses a PN sequence as random numbers, the random-number generation circuit may be guessed at a high risk.

### SUMMARY OF THE INVENTION

The present invention has been made in consideration of the foregoing situation. An object of the present invention is to provide a random-number generation apparatus, a random-number generation method, a random-number generation program which greatly improve safety by making the guessing of the structure of a random-number generation source from generated random numbers difficult, and further reduce the circuit scale and power consumption.

The foregoing object is achieved in one aspect of the present invention through the provision of a random-number generation apparatus for generating random-number data, including a random-number generation source for generating a predetermined bit string; and encryption means for applying predetermined block encryption by using the bit string generated by the random-number generation source, to output the random-number data.

In the random-number generation apparatus, the encryption means applies the predetermined block encryption to the bit string generated by the random-number generation source to generate the random-number data. Therefore, the periodicity of random numbers is excluded to greatly enhance safety.

In the random-number generation apparatus, the encryption means may use a chaining method as a block mode employed when the block encryption is applied to the bit string.

When the encryption means uses a chaining method to apply the predetermined block encryption to the bit string generated by the random-number generation source to generate the random-number data in the random-number generation apparatus, it is made difficult to guess the structure of the random-number generation source from the generated random-number data, and hence, safety is more enhanced. Further, since only one random-number generation source is required, the circuit scale and power consumption are reduced.

The foregoing object is achieved in another aspect of the present invention through the provision of a random-number generation method for generating random-number data, including a bit-string generation step of generating a predetermined bit string by a random-number generation source; and an encryption step of applying predetermined block encryption by using the bit string generated in the bit-string generation step, to output the random-number data.

In the random-number generation method, the predetermined block encryption is applied to the bit string generated by the random-number generation source to generate the random-number data. Therefore, the periodicity of random numbers is excluded to greatly enhance safety.

In the random-number generation method, a chaining method may be used as a block mode employed when the block encryption is applied to the bit string in the encryption step.

When a chaining method is used to apply the predetermined block encryption to the bit string generated by the random-number generation source to generate the random-number data in the random-number generation method, it is made difficult to guess the structure of the random-number generation source from the generated random-number data, and hence, safety is more enhanced. Further, since only one random-number generation source is required, the circuit scale and power consumption of an apparatus which implements the random-number generation method are reduced.

The foregoing object is achieved in yet another aspect of the present invention through the provision of a computer-readable random-number generation program for generating random-number data, including bit-string generation processing for generating a predetermined bit string by a random-number generation source; and encryption processing for applying predetermined block encryption by using the bit string generated in the bit-string generation processing, to output the random-number data.

When the random-number generation program is executed, the predetermined block encryption is applied to the bit string generated by the random-number generation source to generate the random-number data. Therefore, the periodicity of random numbers is excluded to greatly enhance safety.

In the random-number generation program, a chaining method may be used as a block mode employed when the block encryption is applied to the bit string in the encryption processing.

When a chaining method is used to apply the predetermined block encryption to the bit string generated by the random-number generation source to generate the random-number data in the random-number generation program, it is made difficult to guess the structure of the random-number generation source from the generated random-number data, and hence, safety is more enhanced. Further, since only one random-number generation source is required, the circuit scale and power consumption of an apparatus which executes the random-number generation program are reduced.

### BRIEF DESCRIPTION OF THE DRAWINGS

FIG. 1 is a block diagram of a random-number generation apparatus according to a first embodiment of the present invention.

FIG. 2 is a block diagram of a random-number generation apparatus according to a second embodiment of the present invention.

FIG. 3 is a block diagram of a random-number generation apparatus according to a third embodiment of the present invention.

FIG. 4 is a block diagram of a conventional PN-sequence generation apparatus.

FIG. 5 is a view showing the periodicity of a PN sequence generated by the conventional PN-sequence generation apparatus shown in FIG. 4.

### DESCRIPTION OF THE PREFERRED EMBODIMENTS

Embodiments of the present invention will be described below in detail by referring to the drawings.

The embodiments describe random-number generation apparatuses for generating random numbers used, for example, for mutual authentication for confirming the legitimacy of communication parties and during the process of generating a key used in encryption communication for ensuring the safety of data communication to be performed after the authentication. These random-number generation apparatuses apply block encryption to bit strings generated by a predetermined random-number generation source to finally output random-number data. The periodicity of random-number data is excluded to greatly enhance safety.

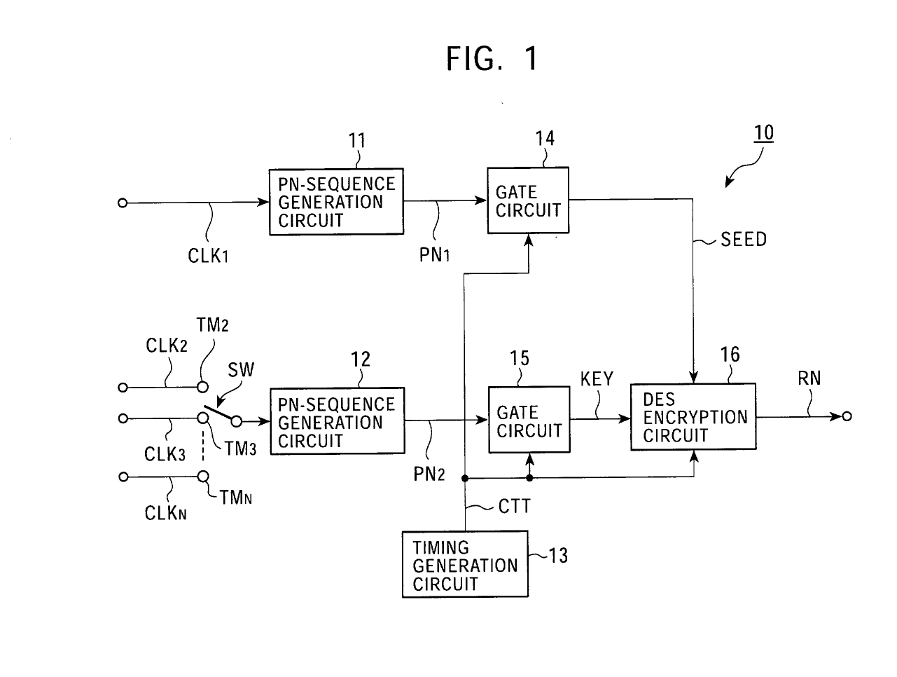

A random-number generation apparatus according to a first embodiment of the present invention will be described first by referring to FIG. 1. A random-number generation apparatus 10 shown in FIG. 1 employs a so-called data encryption standard (DES) encryption method, a private-key cryptosystem, which uses the identical key data for both encryption and decryption, as a block encryption method to be applied to bit strings, and uses two pseudo-random number (PN) sequences independently generated, as bit strings to which the DES encryption processing is applied, that is, seed data and key data.

A technology described in the Japanese Unexamined Patent Application Publication No. 2001-193433, which the present assignee has filed, is used in the random-number generation apparatus 10 to generate a plurality of PN sequences. In addition, the random-number generation apparatus 10 uses a technology in which a predetermined calculation is applied to one PN sequence by using other PN sequences generated according to different clock signals to disturb the periodicity of each PN sequence serving as a random-number generation source in order to reduce a possibility of generating the same random numbers even if the initial value held by a shift register included in a PN-sequence generation circuit for generating PN sequences and the time taken from the start of random-number generation processing to the output of a random number are the same. Therefore, the random-number generation apparatus 10 can generate random numbers having no periodicity and more safety than those generated by the technology described in the Japanese Unexamined Patent Application Publication No. 2001-193433.

As shown in the figure, the random-number generation apparatus 10 includes two PN-sequence generation circuits 11 and 12 for generating PN sequences serving as random-number generation sources, a timing generation circuit 13 for determining the timing of random-number generation processing, two gate circuits 14 and 15 which open according to a control signal CTT sent from the timing generation circuit 13, a DES encryption circuit 16 serving as encryption means for applying DES encryption processing according to the control signal CTT sent from the timing generation circuit 13, and a switch SW for selecting data from a plurality of items of data.

In the random-number generation apparatus 10, these sections can be implemented not only by hardware but also by software. When software is used to implement these sections in the random-number generation apparatus 10, a central processing unit (CPU) in an electronic unit such as a personal computer, for example, executes a random-number generation program for generating random-number data to implement the functions of the sections. The random-number generation program is provided by a predetermined recording medium, such as a so-called compact disc, or a transfer medium such as the Internet.

The PN-sequence generation circuit 11 serving as first pseudo-random-signal generation means operates according to a predetermined first clock signal CLK₁ externally given, and generates a PN sequence PN₁ having, for example, 64 bits which serves as a first pseudo-random signal. The PN-sequence generation circuit 11 sends the generated PN sequence PN₁ to the gate circuit 14.

The PN-sequence generation circuit 12 serving as second pseudo-random-signal generation means operates according to a second clock signal selected by the switch SW which switches randomly, from a plurality of clock signals CLK₂, CLK₃, . . . , and CLK_{N} having frequencies different from each other and externally given, and generates a PN sequence PN₂ having, for example, 64 bits which serves as a second pseudo-random signal and are different from the PN sequence PN₁ generated by the PN-sequence generation circuit 11. The PN-sequence generation circuit 12 sends the generated PN sequence PN₂ to the gate circuit 15.

The timing generation circuit 13 determines the time required from the start of the random-number generation processing to the output of a random number, that is the timing of the random-number generation processing. The timing generation circuit 13 sends the control signal CTT indicating the timing to the gate circuits 14 and 15 and to the DES encryption circuit 16.

The gate circuit 14 opens when the control signal CTT is given from the timing generation circuit 13. When the gate circuit 14 opens, it sends the PN sequence PN₁ sent from the PN-sequence generation circuit 11, to the DES encryption circuit 16 as seed data SEED, and stores it in a register (not shown) of the DES encryption circuit 16.

The gate circuit 15 opens in the same way as the gate circuit 14, when the control signal CTT is given from the timing generation circuit 13. When the gate circuit 15 opens, it sends the PN sequence PN₂ sent from the PN-sequence generation circuit 12, to the DES encryption circuit 16 as key data KEY, and stores it in a register (not shown) of the DES encryption circuit 16.

The DES encryption circuit 16 starts DES encryption processing by using the data SEED sent through the opened gate circuit 14 and the key data KEY sent through the opened gate circuit 15, according to the control signal CTT sent from the timing generation circuit 13. The DES encryption circuit 16 executes the DES encryption processing to generate a bit string having, for example, 64 bits, and outputs the bit string to the outside as random-number data RN.

The switch SW switches among terminals to be selected TM₂, TM₃, . . . , and TM_{N} to which a plurality of clock signals CLK₂, CLK₃, . . . , and CLK_{N} having frequencies different from each other are sent, and is connected to one of them. The switch SW selects one of the terminals to be selected TM₂, TM₃, . . . , and TM_{N}, statistically at random. The clock signal selected by the switch SW is sent to the PN-sequence generation circuit 12.

In the random-number generation apparatus 10, the DES encryption circuit 16 performs the DES encryption processing by using the PN sequence PN₁ generated by the PN-sequence generation circuit 11 and the PN sequence PN₂ generated by the PN-sequence generation circuit 12 as the data SEED and the key data KEY to generate random-number data RN to be finally output.

In the random-number generation apparatus 10, since a clock signal sent to the PN-sequence generation circuit 12 is switched at random among the clock signals CLK₂, CLK₃, . . . , and CLK_{N}, when the timing generation circuit 13 generates the control signal CTT at the same timing every time the power is turned on, for example, the PN-sequence generation circuit 11 generates the same PN-sequence PN₁ every time whereas the PN-sequence generation circuit 12 generates a different PN-sequence PN₂ every time. Therefore, since a different key data KEY is input to the DES encryption circuit 16 every time, the random-number generation apparatus 10 finally outputs different random-number data RN every time.

Since bit diffusion processing is applied in the DES encryption processing, the random-number generation apparatus 10 generates random-number data RN having no relationship with the periodicity of the PN-sequence PN₁ serving as the data SEED.

As described above, in the random-number generation apparatus 10, the DES encryption processing is applied to the two PN sequences PN₁ and PN₂ generated according to clock signals different from each other and serving as data SEED and key data KEY to generate the random-number data RN to be finally output. Therefore, the periodicity of the random-number data RN is excluded, and safety is greatly improved.

In the random-number generation apparatus 10, the fixed clock signal CLK₁ is applied to the PN-sequence generation circuit 11, and the clock signal applied to the PN-sequence generation circuit 12 is switched at random among the clock signals CLK₂, CLK₃, . . . , and CLK_{N}. The clock signal applied to the PN-sequence generation circuit 11 may be switched at random among a plurality of clock signals' having frequencies different from each other in the same way as for the PN-sequence generation circuit 12. In this case, however, it is necessary to make the clock signals applied to the PN-sequence generation circuits 11 and 12 different. In other words, if different clock signals are applied to the PN-sequence generation circuits 11 and 12, the random-number generation apparatus 10 may have any structure.

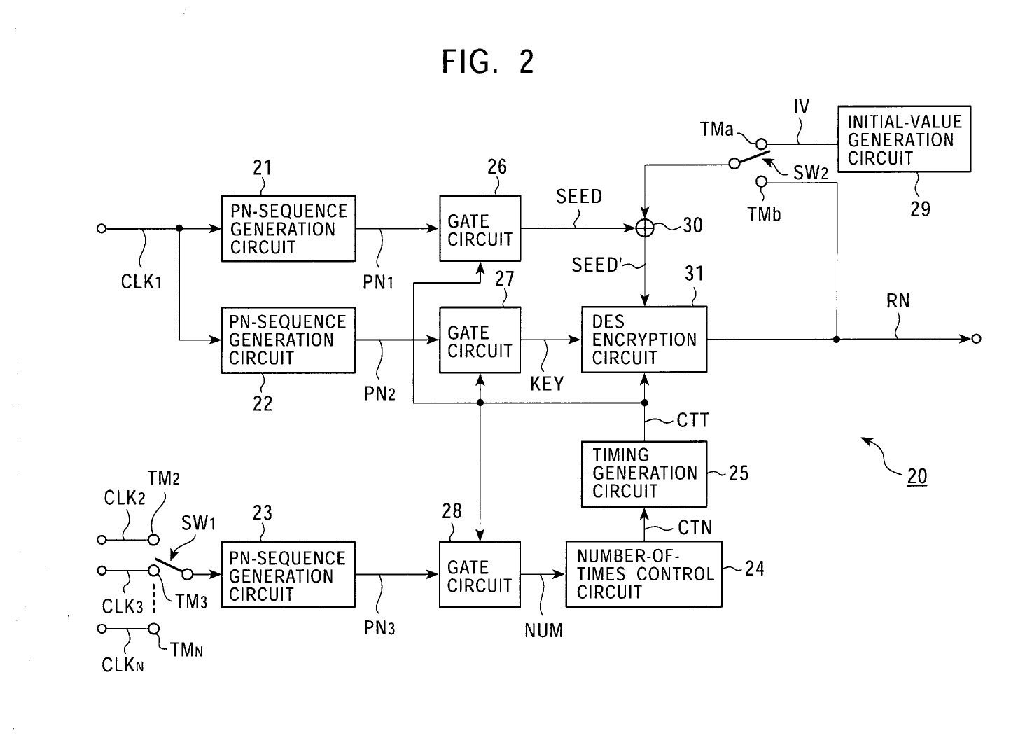

A random-number generation apparatus according to a second embodiment of the present invention will be described next by referring to FIG. 2. A random-number generation apparatus 20 shown in the figure uses a chaining technique as a block mode employed when block encryption is applied to bit strings. In the following description, it is assumed that the DES encryption method is employed as a block encryption method applied to bit strings in the same way as in the random-number generation apparatus 10, described above, and bit strings to which the DES encryption method is applied, that is, seed data and key data, are set to two PN sequences independently generated. As a chaining technique employed when the DES encryption method is applied to bit strings, a so-called cipher block chaining (CBC) mode is used.

As shown in the figure, the random-number generation apparatus 20 includes three PN-sequence generation circuits 21, 22, and 23 for generating PN sequences, a number-of-times control circuit 24 serving as number-of-times control means for controlling the number of times a DES encryption circuit 31, described later, is made to operate in the CBC mode, a timing generation circuit 25 for determining the timing of random-number generation processing, three gate circuits 26, 27, and 28 which open according to a control signal CTT sent from the timing generation circuit 25, an initial-value generation circuit 29 serving as initial-value generation means for generating predetermined initial-value data IV, an exclusive-OR circuit 30 serving as exclusive-OR means for applying an exclusive-OR operation to two input data, the DES encryption circuit 31 serving as encryption means for applying DES encryption processing according to the control signal CTT sent from the timing generation circuit 25, and switches SW₁ and SW₂ for selecting data from a plurality of items of data.

In the random-number generation apparatus 20, these sections can be implemented not only by hardware but also by software, as in the random-number generation apparatus 10, described above. When software is used to implement these sections in the random-number generation apparatus 20, a CPU in an electronic unit such as a personal computer, for example, executes a random-number generation program for generating random-number data to implement the functions of the sections. The random-number generation program is provided by a predetermined recording medium, such as a compact disc, or a transfer medium such as the Internet.

The PN-sequence generation circuits 21 and 22 serving as first pseudo-random-signal generation means and second pseudo-random-signal generation means operate according to a predetermined clock signal CLK₁ externally given, and generate PN sequences PN₁ and PN₂ having, for example, 64 bits which serve as first and second pseudo-random signals. The PN-sequence generation circuits 21 and 22 send the generated PN sequences PN₁ and PN₂ to the gate circuits 26 and 27, respectively.

The PN-sequence generation circuit 23 serving as pseudo-random-signal generation means is provided in order to determine at random the number of times the DES encryption circuit 31 is made to operate in the CBC mode. The PN-sequence generation circuit 23 operates according to a clock signal selected by the switch SW₁ which switches randomly, from a plurality of clock signals CLK₂, CLK₃, . . . , and CLK_{N} having frequencies different from each other and externally given, and generates a PN sequence PN₃ having a predetermined number of bits which serves as a pseudo-random signal. When the PN-sequence generation circuit 23 generates a 10-bit PN sequence PN₃, for example, it generates a value at random among “1” to “1023” in decimal notation. The PN-sequence generation circuit 23 sends the generated PN sequence PN₃ to the gate circuit 28.

The number-of-times control circuit 24 controls the number of times the DES encryption circuit 31 is made to operate in the CBC mode. The number-of-times control circuit 24 determines the number of times the DES encryption circuit 31 is made to operate in the CBC mode, according to number-of-times data NUM, described later, sent through the gate circuit 28 when it is opened. When the PN-sequence generation circuit 23 generates a 10-bit PN sequence PN₃ as described above, for example, the number-of-times control circuit 24 determines the value indicated by the number-of-times data NUM among “1” to “1023” in decimal notation as the number of times the DES encryption circuit 31 is made to operate in the CBC mode. The number-of-times control circuit 24 sends a control signal CTN indicating the number of times the DES encryption circuit 31 is made to operate in the CBC mode to the timing generation circuit 25.

The timing generation circuit 25 determines the time required from the start of the random-number generation processing to the output of a random number, that is, the timing of the random-number generation processing. The timing generation circuit 25 determines the timing of the random-number generation processing according to the control signal CTN sent from the number-of-times control circuit 24, and sends the control signal CTT indicating the timing to the gate circuits 26, 27, and 28 and to the DES encryption circuit 31.

The gate circuit 26 opens when the control signal CTT is given from the timing generation circuit 25. When the gate circuit 26 opens, it sends the PN sequence PN₁ sent from the PN-sequence generation circuit 21, to the exclusive-OR circuit 30 as data SEED.

The gate circuit 27 opens in the same way as the gate circuit 26, when the control signal CTT is given from the timing generation circuit 25. When the gate circuit 27 opens, it sends the PN sequence PN₂ sent from the PN-sequence generation circuit 22, to the DES encryption circuit 31 as key data KEY, and stores it in a register (not shown) of the DES encryption circuit 31.

The gate circuit 28 opens in the same way as the gate circuits 26 and 27, when the control signal CTT is given from the timing generation circuit 25. When the gate circuit 28 opens, it sends the PN sequence PN₃ sent from the PN-sequence generation circuit 23, to the number-of-times control circuit 24 as the number-of-times data NUM the DES encryption circuit 31 is made to operate in the CBC mode.

The initial-value generation circuit 29 generates the predetermined initial-value data IV. The initial-value generation circuit 29 sends the generated initial-value data IV to the exclusive-OR circuit 30 through the switch SW₂, which selects just one data.

The exclusive-OR circuit 30 applies an exclusive-OR operation to data sent through the switch SW₂, which selects just one data, and chosen from the initial-value data TV output from the initial-value generation circuit 29 and the random-number data RN output from the DES encryption circuit 31, and the data SEED sent through the gate circuit 26 when the gate circuit 26 is opened. The exclusive-OR circuit 30 sends the operation result to the DES encryption circuit 31 as seed data SEED′.

The DES encryption circuit 31 starts DES encryption processing by using the seed data SEED′ sent through the exclusive-OR circuit 30 and the key data KEY sent through the gate circuit 27 when it is opened, according to the control signal CTT sent from the timing generation circuit 25. The DES encryption circuit 31 executes the DES encryption processing to generate a bit string having, for example, 64 bits. The DES encryption circuit 31 sends the random-number data RN formed of the generated bit string to the exclusive-OR circuit 30 through the switch SW₂ such that the data is used for calculating seed data for the next DES encryption processing. The DES encryption circuit 31 outputs a bit string obtained after the DES encryption processing is performed the number of times determined by the number-of-times control circuit 24, as the final random-number data RN to the outside.

The switch SW₁ switches among terminals to be selected TM₂, TM₃, . . . , and TM_{N} to which a plurality of clock signals CLK₂, CLK₃, . . . , and CLK_{N} having frequencies different from each other are sent, and is connected to one of them. The switch SW₁ selects one of the terminals to be selected TM₂, TM₃, . . . , and TM_{N}, statistically at random. The clock signal selected by the switch SW₁ is sent to the PN-sequence generation circuit 23.

The switch SW₂ is connected-to a terminal to be selected TMa in its initial state such that the initial-value data IV generated by the initial-value generation circuit 29 is sent to the exclusive-OR circuit 30. In other words, the switch SW₂ is connected to the terminal to be selected TMa in the first DES encryption processing performed by the DES encryption circuit 31. In the second and subsequent DES encryption processing performed by the DES encryption circuit 31, the switch SW₂ is connected to a terminal to be selected TMb such that the random-number data RN obtained as a result of the previous DES encryption processing performed by the DES encryption circuit 31 is used for calculating seed data for the current DES encryption processing. The data selected by the switch SW₂ is sent to the exclusive-OR circuit 30.

In the random-number generation apparatus 20, the DES encryption circuit 31 performs the DES encryption processing in the CBC mode by using the PN sequence PN₁ generated by the PN-sequence generation circuit 21 and the PN sequence PN₂ generated by the PN-sequence generation circuit 22 as the data SEED and the key data KEY, according to the number-of-times data NUM indicated by the PN sequence PN₃ generated by the PN-sequence generation circuit 23. More specifically, in the random-number generation apparatus 20, the DES encryption circuit 31 performs the DES encryption processing by using the result obtained when an exclusive-OR operation is applied to the initial-value data generated by the initial-value generation circuit 29 and the data SEED, as data SEED′ in the first DES encryption processing, and the DES encryption circuit 31 repeats the DES encryption processing by using the result obtained when an exclusive-OR operation is applied to the random-number data RN obtained in the previous DES encryption processing and the data SEED, as data SEED′ in the second and subsequent DES encryption processing. Then, the random-number generation apparatus 20 outputs a bit string obtained when the DES encryption circuit 31 performs the DES encryption processing the number of times based on the number-of-times data NUM indicated by the PN sequence PN₃ generated by the PN-sequence generation circuit 23, as the finally output random-number data RN.

In the random-number generation apparatus 20, since the clock signal sent to the PN-sequence generation circuit 23 is switched at random, the data NUM of the number of times the DES encryption circuit 31 is made to operate in the CBC mode is changed. Therefore, the random-number generation apparatus 20 finally outputs different random-number data RN every time.

Since bit diffusion processing is applied in the DES encryption processing, the random-number generation apparatus 20 generates random-number data RN having no relationship with the periodicity of the PN-sequence PN₁ serving as the data SEED, in the same way as the random-number generation apparatus 10, described above.

As described above, the random-number generation apparatus 20 uses the CBC mode in the DES encryption processing to generate the finally output random-number data RN. Therefore, the periodicity of the random-number data RN is excluded, and it is made difficult to guess the structure of the original random-number generation source from generated random-number data RN. Consequently, the random-number generation apparatus 20 greatly improves safety.

In the random-number generation apparatus 20, the fixed clock signal CLK₁ is applied to the PN-sequence generation circuits 21 and 22, and the clock signal applied to the PN-sequence generation circuit 23 is switched at random among the clock signals CLK₂, CLK₃, . . . , and CLK_{N}. The clock signal applied to either or both of the PN-sequence generation circuits 21 and 22 may be switched at random among a plurality of clock signals having frequencies different from each other in the same way as for the PN-sequence generation circuit 23. In this case, however, it is necessary to make the clock signals applied to the PN-sequence generation circuits 21 and 22 different.

The random-number generation apparatus 20 uses the CBC mode as a block mode employed when the DES encryption processing is applied to bit strings. Other chaining techniques, such as a k-bit output feedback (OFB) mode and a k-bit cipher feedback (CFB) mode may be used.

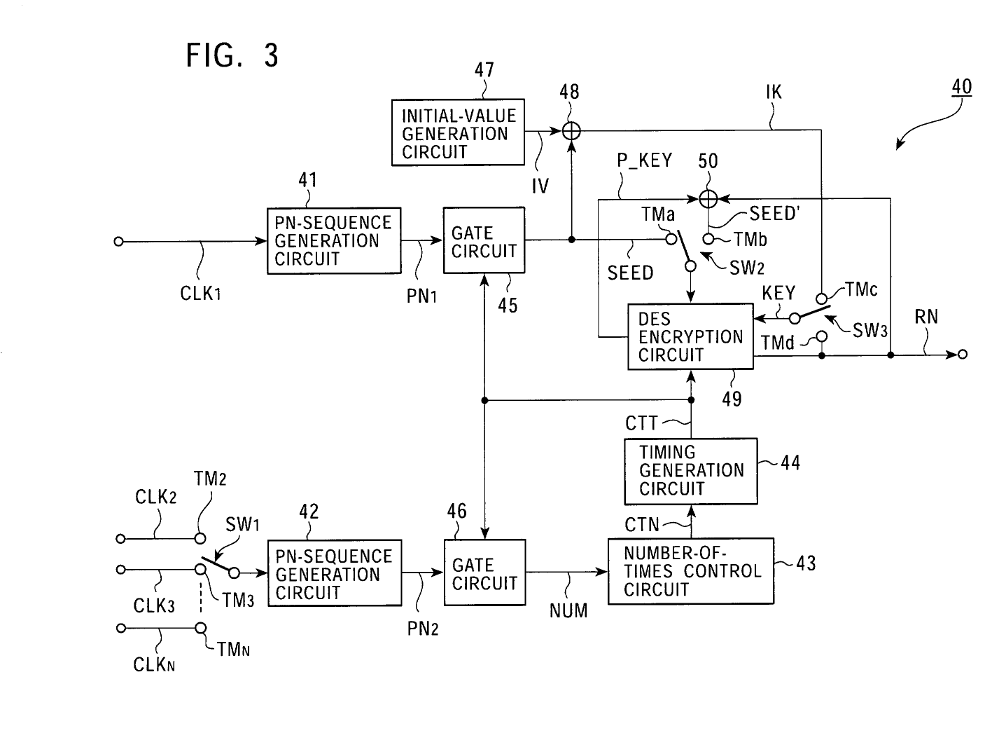

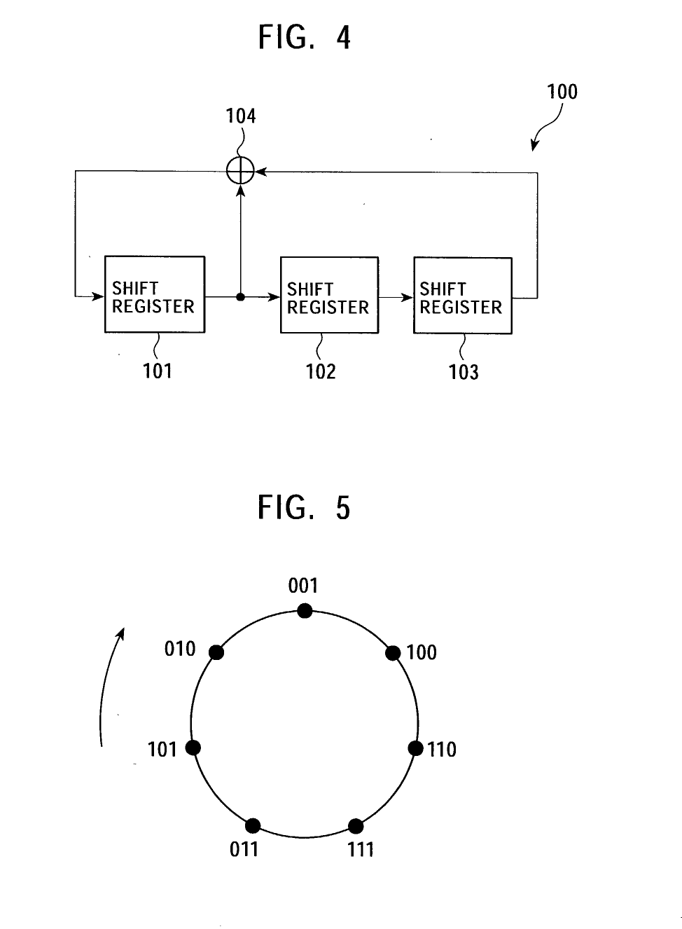

A random-number generation apparatus according to a third embodiment of the present invention will be described next by referring to FIG. 3. In a random-number generation apparatus 40 shown in the figure, the number of PN-sequence generation circuits serving as random-number generation sources is reduced and seed data is generated only once. In the following description, it is assumed that the DES encryption method is employed as a block encryption method applied to bit strings in the same way as in the random-number generation apparatuses 10 and 20, described above, and bit strings to which the DES encryption processing is applied, that is, seed data and key data, are set to one PN sequence generated in common. A chaining technique is adapted as a block mode used when the DES encryption processing is applied to bit strings. As the chaining technique, a CBC mode is used as in the random-number generation apparatus 20, described above.

As shown in the figure, the random-number generation apparatus 40 includes two PN-sequence generation circuits 41 and 42 for generating PN sequences, a number-of-times control circuit 43 serving as number-of-times control means for controlling the number of times a DES encryption circuit 49, described later, is made to operate in the CBC mode, a timing generation circuit 44 for determining the timing of random-number generation processing, two gate circuits 45 and 46 which open according to a control signal CTT sent from the timing generation circuit 44, an initial-value generation circuit 47 serving as initial-value generation means for generating predetermined initial-value data IV, exclusive-OR circuits 48 and 50 for applying an exclusive-OR operation to two input data, the DES encryption circuit 49 serving as encryption means for applying DES encryption processing according to the control signal CTT sent from the timing generation circuit 44, and three switches SW₁, SW₂, and SW₃ for selecting data from a plurality of items of data.

In the random-number generation apparatus 40, these sections can be implemented not only by hardware but also by software, as in the random-number generation apparatuses 10 and 20, described above. When software is used to implement these sections in the random-number generation apparatus 40, a CPU in an electronic unit such as a personal computer, for example, executes a random-number generation program for generating random-number data to implement the functions of the sections. The random-number generation program is provided by a predetermined recording medium, such as a compact disc, or a transfer medium such as the Internet.

The PN-sequence generation circuit 41 serving as first pseudo-random-signal generation means operates according to a predetermined clock signal CLK₁ externally given, and generates a PN sequence PN₁ having, for example, 64 bits which serves as a first pseudo-random signal. The PN-sequence generation circuit 41 sends the generated PN sequence PN₁ to the gate circuit 45.

The PN-sequence generation circuit 42 serving as pseudo-random-signal generation means is provided in order to determine at random the number of times the DES encryption circuit 49 is made to operate in the CBC mode. The PN-sequence generation circuit 42 operates according to a clock signal selected by the switch SW1 which switches randomly, from a plurality of clock signals CLK₂, CLK₃, . . . , and CLK_{N} having frequencies different from each other and externally given, and generates a PN sequence PN₂ having a predetermined number of bits which serves as a pseudo-random signal. When the PN-sequence generation circuit 42 generates a 10-bit PN sequence PN₂, for example, it generates a value at random among “1” to “1023” in decimal notation. The PN-sequence generation circuit 42 sends the generated PN sequence PN₂ to the gate circuit 46.

The number-of-times control circuit 43 controls the number of times the DES encryption circuit 49 is made to operate in the CBC mode. The number-of-times control circuit 43 determines the number of times the DES encryption circuit 49 is made to operate in the CBC mode, according to number-of-times data NUM, described later, sent through the gate circuit 46 when it is opened. When the PN-sequence generation circuit 42 generates a 10-bit PN sequence PN₂ as described above, for example, the number-of-times control circuit 43 determines the value indicated by the number-of-times data NUM among “1” to “1023” in decimal notation as the number of times the DES encryption circuit 49 is made to operate in the CBC mode. The number-of-times control circuit 43 sends a control signal CTN indicating the number of times the DES encryption circuit 49 is made to operate in the CBC mode to the timing generation circuit 44.

The timing generation circuit 44 determines the time required from the start of the random-number generation processing to the output of a random number, that is, the timing of the random-number generation processing. The timing generation circuit 44 determines the timing of the random-number generation processing according to the control signal CTN sent from the number-of-times control circuit 43, and sends the control signal CTT indicating the timing to the gate circuits 45 and 46 and to the DES encryption circuit 49.

The gate circuit 45 opens when the control signal CTT is given from the timing generation circuit 44. When the gate circuit 45 opens, it sends the PN sequence PN₁ sent from the PN-sequence generation circuit 41, to the exclusive-OR circuit 48 as data SEED, and also to the DES encryption circuit 49 through the switch SW₂, which switches to select one of the connections.

The gate circuit 46 opens in the same way as the gate circuit 45, when the control signal CTT is given from the timing generation circuit 44. When the gate circuit 46 opens, it sends the PN sequence PN₂ sent from the PN-sequence generation circuit 42, to the number-of-times control circuit 43 as the number-of-times data NUM the DES encryption circuit 49 is made to operate in the CBC mode.

The initial-value generation circuit 47 generates the predetermined initial-value data IV. The initial-value generation circuit 47 sends the generated initial-value data IV to the exclusive-OR circuit 48.

The exclusive-OR circuit 48 serving as first exclusive-OR means applies an exclusive-OR operation to the initial-value data IV sent from the initial-value generation circuit 47 and the data SEED sent through the gate circuit 45 when the gate circuit 45 is opened. The exclusive-OR circuit 48 sends the operation-result data IK to the DES encryption circuit 49 through the switch SW₃, which switches to select one of the connections, as key data KEY used in the first DES encryption processing performed by the DES encryption circuit 49.

The DES encryption circuit 49 starts DES encryption processing by using the seed data SEED sent through the gate circuit 45 when it is opened and through the switch SW₂ and the key data KEY sent through the switch SW₃ from the exclusive-OR circuit 48, according to the control signal CTT sent from the timing generation circuit 44. The DES encryption circuit 49 executes the DES encryption processing to generate a bit string having, for example, 64 bits. The DES encryption circuit 49 sends the random-number data RN formed of the generated bit string to the exclusive-OR circuit 50 and inputs the random-number data RN again through the switch SW₃ as key data KEY to be used in the next DES encryption processing. The DES encryption circuit 49 also sends the key data KEY used in the previous DES encryption processing to the exclusive-OR circuit 50 such that the key data is to be used for calculating seed data in the current DES encryption processing. In other words, in the first DES encryption processing, the DES encryption circuit 49 uses the data SEED sent through the gate circuit 45 when it is opened and through the switch SW₂, as seed data, and the key data KEY sent through the switch SW₃ from the exclusive-OR circuit 48. In the second or subsequent DES encryption processing, the DES encryption circuit 49 sets the key data used in the previous DES encryption processing to pre-key data P_KEY, and uses data SEED′ obtained when an exclusive-OR operation is applied to the pre-key data P_KEY and the generated random-number data RN, as seed data in the current DES encryption processing, and the generated random-number data RN as key data KEY in the current DES encryption processing. The DES encryption circuit 49 outputs a bit string obtained after the DES encryption processing is performed the number of times determined by the number-of-times control circuit 43, as the final random-number data RN to the outside.

The exclusive-OR circuit 50 serving as second exclusive-OR means applies an exclusive-OR operation to the pre-key data P_KEY sent from the DES encryption circuit 49 and the random-number data RN sent from the DES encryption circuit 49, and sends the operation result to the DES encryption circuit 49 through the switch SW₂ as seed data SEED′.

The switch SW₁ switches among terminals to be selected TM₂, TM₃, . . . , and TM_{N} to which a plurality of clock signals CLK₂, CLK₃, . . . , and CLK_{N} having frequencies different from each other are sent, and is connected to one of them. The switch SW₁ selects one of the terminals to be selected TM₂, TM₃, . . . , and TM_{N}, statistically at random. The clock signal selected by the switch SW₁ is sent to the PN-sequence generation circuit 42.

The switch SW₂ is connected to a terminal to be selected TMa in its initial state such that the data SEED sent through the gate circuit 45 when it is opened is sent to the DES encryption circuit 49. In other words, the switch SW₂ is connected to the terminal to be selected TMa in the first DES encryption processing performed by the DES encryption circuit 49. In the second and subsequent DES encryption processing performed by the DES encryption circuit 49, the switch SW₂ is connected to a terminal to be selected TMb such that the data SEED′ sent from the exclusive-OR circuit 50 is sent to the DES encryption circuit 49. The data selected by the switch SW₂ is sent to the DES encryption circuit 49 as seed data.

The switch SW₃ is connected to a terminal to be selected TMc in its initial state such that the data IK sent from the exclusive-OR circuit 48 is sent to the DES encryption circuit 49. In other words, the switch SW₃ is connected to the terminal to be selected TMc in the first DES encryption processing performed by the DES encryption circuit 49. In the second and subsequent DES encryption processing performed by the DES encryption circuit 49, the switch SW₃ is connected to a terminal to be selected TMd such that the random-number data RN output from the DES encryption circuit 49 is again input to the DES encryption circuit 49. The data selected by the switch SW₃ is sent to the DES encryption circuit 49 as key data KEY.

In the random-number generation apparatus 40, as seed data input to the DES encryption circuit 49, the PN sequence PN₁ generated by the PN-sequence generation circuit 41 is used under the name of data SEED in the first DES encryption processing, and the result obtained by applying an exclusive-OR operation to the random-number data RN obtained as the result of the previous DES encryption processing performed by the DES encryption circuit 49 and the pre-key data P_KEY used as key data in the previous DES encryption processing is used under the name of data SEED′ in the second and subsequent DES encryption processing.

In the random-number generation apparatus 40, as key data input to the DES encryption circuit 49, the result obtained by applying an exclusive-OR operation to the PN sequence PN₁ generated by the PN-sequence generation circuit 41 and the initial-value data IV generated by the initial-value generation circuit 47 is used under the name of the key data KEY in the first DES encryption processing, and the random-number data RN obtained as the result of the previous DES encryption processing performed by the DES encryption circuit 49 is used under the name of the key data KEY in the second and subsequent DES encryption processing. The random-number generation apparatus 40 outputs the bit string obtained when the DES encryption circuit 49 executes the DES encryption processing the number of times based on the number-of-times data NUM indicated by the PN sequence PN₂ generated by the PN-sequence generation circuit 42, as the finally output random-number data RN.

In the random-number generation apparatus 40, since the clock signal sent to the PN-sequence generation circuit 42 is switched at random, the data NUM of the number of times the DES encryption circuit 49 is made to operate in the CBC mode is changed. Therefore, the random-number generation apparatus 40 finally outputs different random-number data RN every time.

Since bit diffusion processing is applied in the DES encryption processing, the random-number generation apparatus 40 generates random-number data RN having no relationship with the periodicity of the PN-sequence PN₁ serving as the data SEED, in the same way as the random-number generation apparatuses 10 and 20, described above.

As described above, since the random-number generation apparatus 40 needs to have one PN sequence input to the DES encryption circuit 49, it is not necessary to separately provide PN-sequence generation circuits as generation sources of seed data and key data, and thus, the circuit scale is reduced compared with the random-number generation apparatus 20, described above.

Since the random-number generation apparatus 40 does not need to use the PN sequence PN₁ generated by the PN-sequence generation circuit 41 in the second and subsequent DES encryption processing performed by the DES encryption circuit 49, after the PN-sequence generation circuit 41 operates once, it is not necessary to operate the PN-sequence generation circuit 41, and thus, power consumption is reduced.

In addition, the random-number generation apparatus 40 uses the CBC mode in the DES encryption processing to generate the finally output random-number data RN. Therefore, the periodicity of the random-number data RN is excluded, and it is made difficult to guess the structure of the original random-number generation source from generated random-number data RN. Consequently, the random-number generation apparatus 40 greatly improves safety.

The random-number generation apparatus 40 is, for example, suited to a case in which power consumption needs to be reduced as much as possible, such as for a so-called non-contact-type semiconductor memory card having a communication function, which has been examined for transportation toll collection and so-called electronic money.

In the random-number generation apparatus 40, the fixed clock signal CLK₁ is applied to the PN-sequence generation circuit 41, and the clock signal applied to the PN-sequence generation circuit 42 is switched at random among the clock signals CLK₂, CLK₃, . . . , and CLK_{N}. The clock signal applied to the PN-sequence generation circuits 41 may be switched at random among a plurality of clock signals having frequencies different from each other in the same way as for the PN-sequence generation circuit 42.

The random-number generation apparatus 40 uses the CBC mode as a block mode when the DES encryption processing is applied to bit strings. Other chaining techniques, such as the OFB mode and the CFB mode, described above, may be used.

Further, the random-number generation apparatus 40 may be configured such that the output random-number data RN is not input in units of blocks as data used for the next DES encryption processing, but a predetermined number of blocks of output random-number data RN is stored and predetermined partial data in the plurality of blocks of the random-number data RN stored is used for the next DES encryption processing.

As described above, since the random-number generation apparatuses 10, 20, and 40 apply the DES encryption processing to bit strings generated by a predetermined random-number generation source to generate the finally output random-number data RN, the periodicity of random numbers is excluded, and hence, safety is greatly enhanced.

Especially, since the random-number generation apparatuses 20 and 40 use the CBC mode in the DES encryption processing, the periodicity of the finally output random-number data RN is excluded, and it is made difficult to guess the structure of the original random-number generation source from the generated random-number data RN. Consequently, safety is more enhanced.

Further, the random-number generation apparatus 40 uses a chaining technique to continuously generate seed data and key data used in the second and subsequent DES encryption processing from one PN sequence serving as seed data. Therefore, only one PN-sequence generation circuit serving as a random-number generation source is required, and thus, the circuit scale and power consumption are reduced.

The present invention is not limited to the above-described embodiments. Tn the foregoing embodiments, for example, the DES encryption method is used as a block encoding method to be applied to bit strings. A block encryption method other than the DES encryption method can also be applied in the present invention.

Tn the above-described embodiments, a PN-sequence generation circuit is used as a random-number generation source. Other random-number generation sources may be used in the present invention.

As described above, various modifications are possible within the scope of the present invention.

What is claimed is:

1. A random-number generation apparatus for generating random-number data, comprising:
a random-number generation source for generating a predetermined bit string; and
encryption means for applying predetermined block encryption by using the bit string generated by the random-number generation source, to output the random-number data.

2. A random-number generation apparatus according to claim 1, wherein the random-number generation source comprises:
first pseudo-random-signal generation means for generating a first pseudo-random signal having a predetermined number of bits, according to a predetermined first clock signal; and
second pseudo-random-signal generation means for generating a second pseudo-random signal having a predetermined number of bits, different from the first pseudo-random signal, according to a predetermined second clock signal different from the predetermined first clock signal.

3. A random-number generation apparatus according to claim 2, wherein the encryption means performs block encryption by using the first pseudo-random signal generated by the first pseudo-random-signal generation means, as seed data, and the second pseudo-random signal generated by the second pseudo-random-signal generation means, as key data.

4. A random-number generation apparatus according to claim 2, wherein the second pseudo-random-signal generation means generates the second pseudo-random signal according to the predetermined second clock signal selected at random from a plurality of clock signals having frequencies different from each other.

5. A random-number generation apparatus according to claim 2, wherein the first pseudo-random signal and the second pseudo-random signal are pseudo-random-number sequences.

6. A random-number generation apparatus according to claim 1, wherein the encryption means uses a chaining technique as a block mode employed when block encryption is applied to the bit string.

7. A random-number generation apparatus according to claim 6, further comprising number-of-times control means for controlling the number of times the encryption means is made to operate with the chaining technique,
wherein the encryption means outputs a bit string obtained when block encryption is executed the number of times determined by the number-of-times control means, as the random-number data.

8. A random-number generation apparatus according to claim 7, further comprising pseudo-random-signal generation means for generating a pseudo-random signal having a predetermined number of bits, according to a clock signal selected at random from a plurality of clock signals having frequencies different from each other,
wherein the number-of-times control means determines the number of times the encryption means is made to operate with the chaining technique, according to the number-of-times data formed of the pseudo-random signal generated by the pseudo-random-signal generation means.

9. A random-number generation apparatus according to claim 8, wherein the pseudo-random signal is a pseudo-random-number sequence.

10. A random-number generation apparatus according to claim 6,
wherein the random-number generation source comprises:
first pseudo-random-signal generation means for generating a first pseudo-random signal having a predetermined number of bits, according to a predetermined clock signal; and
second pseudo-random-signal generation means for generating a second pseudo-random signal having a predetermined number of bits, different from the first pseudo-random signal, according to the same clock signal as the above-described clock signal.

11. A random-number generation apparatus according to claim 10, further comprising initial-value generation means for generating predetermined initial-value data; and
exclusive-OR means for applying an exclusive-OR operation to two input data items,
wherein the encryption means uses data obtained when the exclusive-OR means applies an exclusive-OR operation to the initial-value data generated by the initial-value generation means and the first pseudo-random signal generated by the first pseudo-random-signal generation means, as seed data, and the second pseudo-random signal generated by the second pseudo-random-signal generation means, as key data to execute block encryption in first block encryption processing, and
the encryption means uses data obtained when the exclusive-OR means applies an exclusive-OR operation to the resultant data obtained in the previous block encryption and the first pseudo-random signal generated by the first pseudo-random-signal generation means, as seed data in the current block encryption, and the second pseudo-random signal generated by the second pseudo-random-signal generation means, as key data in the current block encryption to execute block encryption in second and subsequent block encryption processing.

12. A random-number generation apparatus according to claim 10, wherein the first pseudo-random signal and the second pseudo-random signal are pseudo-random-number sequences.

13. A random-number generation apparatus according to claim 6, wherein the random-number generation source comprises first pseudo-random-signal generation means for generating a first pseudo-random signal having a predetermined number of bits, according to a predetermined clock signal.

14. A random-number generation apparatus according to claim 13, further comprising initial-value generation means for generating predetermined initial-value data; and
first exclusive-OR means and second exclusive-OR means for applying an exclusive-OR operation to two input data items,
wherein the encryption means uses the first pseudo-random signal generated by the first pseudo-random-signal generation means, as seed data, and data obtained when the first exclusive-OR means applies an exclusive-OR operation to the initial-value data generated by the initial-value generation means and the first pseudo-random signal generated by the first pseudo-random-signal generation means, as key data to execute block encryption in first block encryption processing, and
the encryption means uses data obtained when the second exclusive-OR means applies an exclusive-OR operation to the resultant data obtained in the previous block encryption and the key data used in the previous block encryption, as seed data, and the resultant data obtained in the previous block encryption, as key data in the current block encryption to execute block encryption in second and subsequent block encryption processing.

15. A random-number generation apparatus according to claim 13, wherein the first pseudo-random signal is a pseudo-random-number sequence.

16. A random-number generation apparatus according to claim 6, wherein the encryption means uses a cipher block chaining mode as the chaining technique.

17. A random-number generation apparatus according to claim 1, wherein the encryption means uses a data encryption standard encryption method.

18. A random-number generation method for generating random-number data, comprising:
a bit-string generation step of generating a predetermined bit string by a random-number generation source; and
an encryption step of applying predetermined block encryption by using the bit string generated in the bit-string generation step, to output the random-number data.

19. A random-number generation method according to claim 18,
wherein the bit-string generation step comprises:
a first pseudo-random-signal generation step of generating a first pseudo-random signal having a predetermined number of bits, according to a predetermined first clock signal; and
a second pseudo-random-signal generation step of generating a second pseudo-random signal having a predetermined number of bits, different from the first pseudo-random signal, according to a predetermined second clock signal different from the predetermined first clock signal.

20. A random-number generation method according to claim 19, wherein, in the encryption step, block encryption is performed by using the first pseudo-random signal generated in the first pseudo-random-signal generation step, as seed data and the second pseudo-random signal generated in the second pseudo-random-signal generation step, as key data.

21. A random-number generation method according to claim 19, wherein, in the second pseudo-random-signal generation step, the second pseudo-random signal is generated according to the predetermined second clock signal selected at random from a plurality of clock signals having frequencies different from each other.

22. A random-number generation method according to claim 19, wherein the first pseudo-random signal and the second pseudo-random signal are pseudo-random-number sequences.

23. A random-number generation method according to claim 18, wherein, in the encryption step, a chaining technique is used as a block mode employed when block encryption is applied to the bit string.

24. A random-number generation method according to claim 23, further comprising a number-of-times control step of controlling the number of times an operation is made with the chaining technique in the encryption step,
wherein, in the encryption step, a bit string obtained when block encryption is executed the number of times determined by the number-of-times control step is output as the random-number data.

25. A random-number generation method according to claim 24, further comprising a pseudo-random-signal generation step of generating a pseudo-random signal having a predetermined number of bits, according to a clock signal selected at random from a plurality of clock signals having frequencies different from each other,
wherein, in the number-of-times control step, the number of times an operation is made with the chaining method in the encryption step is determined according to number-of-times data formed of the pseudo-random signal generated in the pseudo-random-signal generation step.

26. A random-number generation method according to claim 25, wherein the pseudo-random signal is a pseudo-random-number sequence.

27. A random-number generation method according to claim 23, wherein the bit-string generation step comprises:
a first pseudo-random-signal generation step of generating a first pseudo-random signal having a predetermined number of bits, according to a predetermined clock signal; and
a second pseudo-random-signal generation step of generating a second pseudo-random signal having a predetermined number of bits, different from the first pseudo-random signal, according to the same clock signal as the above-described clock signal.

28. A random-number generation method according to claim 27, further comprising an initial-value generation step of generating a predetermined initial-value data; and
an exclusive-OR step of applying an exclusive-OR operation to two input data items,
wherein, in the encryption step, data obtained when an exclusive-OR operation is applied in the exclusive-OR step to the initial-value data generated in the initial-value generation step and the first pseudo-random signal generated in the first pseudo-random-signal generation step is used as seed data, and the second pseudo-random signal generated in the second pseudo-random-signal generation step is used as key data to execute block encryption in first block encryption processing, and
data obtained when an exclusive-OR operation is applied in the exclusive-OR step to the resultant data obtained in the previous block encryption and the first pseudo-random signal generated in the first pseudo-random-signal generation step is used as seed data in the current block encryption, and the second pseudo-random signal generated in the second pseudo-random-signal generation step is used as key data in the current block encryption to execute block encryption in second and subsequent block encryption processing.

29. A random-number generation method according to claim 27, wherein the first pseudo-random signal and the second pseudo-random signal are pseudo-random-number sequences.

30. A random-number generation method according to claim 23, wherein the bit-string generation step comprises first pseudo-random-signal generation step of generating a first pseudo-random signal having a predetermined number of bits, according to a predetermined clock signal.

31. A random-number generation method according to claim 30, further comprising an initial-value generation step of generating predetermined initial-value data; and
a first exclusive-OR step and a second exclusive-OR step of applying an exclusive-OR operation to two input data items,
wherein, in the encryption step, the first pseudo-random signal generated in the first pseudo-random-signal generation step is used as seed data, and data obtained when an exclusive-OR operation is applied in the first exclusive-OR step to the initial-value data generated in the initial-value generation step and the first pseudo-random signal generated in the first pseudo-random-signal generation step is used as key data to execute block encryption in first block encryption processing, and
data obtained when an exclusive-OR operation is applied in the second exclusive-OR step to the resultant data obtained in the previous block encryption and the key data used in the previous block encryption is used as seed data, and the resultant data obtained in the previous block encryption is used as key data in the current block encryption to execute block encryption in second and subsequent block encryption processing.

32. A random-number generation method according to claim 30, wherein the first pseudo-random signal is a pseudo-random-number sequence.

33. A random-number generation method according to claim 23, wherein a cipher block chaining mode is used in the encryption step as the chaining technique.

34. A random-number generation method according to claim 18, wherein a data encryption standard encryption method is used in the encryption step.

35. A computer-readable random-number generation program for generating random-number data, comprising:
bit-string generation processing for generating a predetermined bit string by a random-number generation source; and
encryption processing for applying predetermined block encryption by using the bit string generated in the bit-string generation processing, to output the random-number data.

36. A random-number generation program according to claim 35, wherein, in the encryption processing, a chaining technique is used as a block mode employed when block encryption is applied to the bit string.
